(19) United States
(12) Patent Application Publication
(10) Pub. No.: US 2002/0098877 A1
(43) Pub. Date: Jul. 25, 2002

(54) Boom actuated communication headset

(76) Inventor: Abraham Glezerman, Tel-Aviv (IL)

Correspondence Address: DARBY & DARBY P.C., 805 Third Avenue, New York, NY, 10022, US

(21) Appl. No.: 09/770,707

(22) Filed: Jan. 25, 2001

(51) Int. Cl. H04B 1/38

(52) U.S. Cl. 455/568; 455/90; 455/575

(57) ABSTRACT

A wireless communication headset for attachment to glasses or sunglasses comprises a transceiver within a housing for bi-directional communication with a communication device, a boom hingedly connected to the housing, a microphone affixed to the boom, an earphone connected to the transceiver, and a grasp shaped to secure the housing to the temple arm of a pair of glasses. Preferably, movement of the boom causes at least a portion of the circuitry within the communication headset to be actuated.

### FIELD OF THE INVENTION

The present invention relates to communication systems, and, more particularly, to improvements in wireless headsets for cellular telephones and the like.

### BACKGROUND OF THE INVENTION

There is a growing concern about radiation emanating from placing a cellular telephone close to the brain. Recent studies by the UK Independent Expert Group on Mobile Phones emphasizes, in particular, potential health risks to children. Experts in Germany claim that extensive cellular telephone use is likely to increase threefold the risk of cancer in the eye.

A final determination on this issue is still several years away and still may not provide clear guidance to consumers.

Traditional headsets involve inconveniences such as dangling wires between the ear and the cellular telephone. In addition, there is concern that the wire connecting the earphones to the cellular telephone may concentrate radiation toward the brain. Moreover, present headset designs are either cumbersome or unsightly.

What is needed in the art is a communication headset that solves one or more of the foregoing problems. The present invention satisfies this and other needs.

### SUMMARY OF THE INVENTION

In one aspect of the present invention, a wireless communication headset for attachment to glasses or sunglasses is described. The communication headset comprises a transceiver within a housing for bi-directional communication with a communication device, a boom hingedly connected to the housing, a microphone affixed to the boom, an earphone connected to the transceiver, and a grasp shaped to secure the housing to the temple arm of a pair of glasses.

Preferably, movement of the boom causes at least a portion of the circuitry within the communication headset to be actuated, and the communication headset includes circuitry to respond to such movement.

These and other aspects, features, steps and advantages can be appreciated further from the accompanying Drawing Figures and Detailed Description of a Preferred Embodiment.

### BRIEF DESCRIPTION OF THE DRAWING FIGURES

FIG. 1 is a perspective view of a preferred embodiment of a communication headset in accordance with the invention;

FIG. 2A illustrates a grasp used to mount the communication headset of FIG. 1 to the temple arm of a pair of glasses, in accordance with the preferred embodiment of the invention;

FIG. 2B illustrates a first alternative arrangement for the grasp;

FIG. 2C illustrates a second alternative arrangement for the grasp;

FIG. 3 is a side plan view of the communication headset of FIG. 1, shown actuated and in its intended environment attached to the temple arm of a pair of glasses;

FIG. 4 is the side plan view of FIG. 3, now shown in a de-actuated, unobtrusive position; and

FIG. 5 is the perspective view of FIG. 1, now shown partially in section.

### DETAILED DESCRIPTION OF CERTAIN EMBODIMENTS

By way of overview and introduction, the present invention provides a communication headset that mounts easily and directly to the temple arm of a pair of glasses, for example, prescription glasses or sunglasses. The construction of the preferred embodiment permits the headset to be relatively unassuming compared to prior art headsets. Moreover, the preferred embodiment provides convenience to the user by simplifying the process of commencing or completing a telephone call by actuating a cellular telephone simply by positioning the microphone proximate the user's mouth.

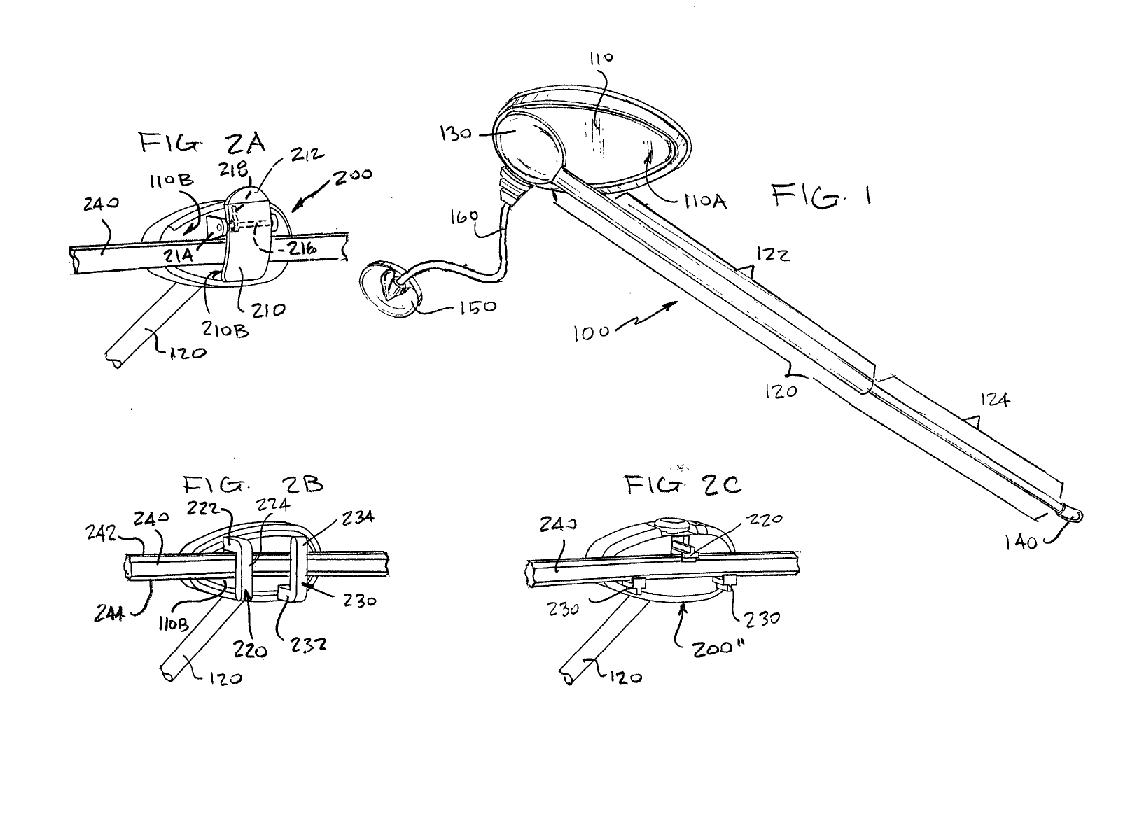

With reference now to FIG. 1, the communication headset 100 of the preferred embodiment is configured to be mounted on the temple arm of a conventional pair of eye glasses or sunglasses. The communication headset includes a housing 110 which is positioned about transceiver circuitry, described below. The housing 110 has a front surface 110A, upon which is mounted a hinge 130. A boom 120 has one end connected to the hinge 130 and extends away from the housing 110 to a microphone 140. Preferably, the boom 120 includes at least first and second telescoping segments 122, 124. The telescoping segments are preferably coaxially aligned and slidable relative to one another to permit manual adjustment of the position of the microphone 140 relative to the mouth of the user (see FIG. 3). A first segment of the boom 120 is connected to the hinge 130 whereas another segment 124 of the boom has the microphone 140 affixed thereto. The segments 122, 124 space the microphone 140 remotely from the housing 110 with the hinge 130 permitting the microphone to be rotated relative to the housing 110 to change the operative state of the communication headset 100 between actuated and de-actuated states.

The communication headset 110 further includes an earphone 150 which is electrically connected by cable 160 to the transceiver circuitry within the housing. As it is understood by those of skill in the art, the cable 160 includes at least a pair of conductive wires which are insulated from one another. Preferably, the cable 160 has a stiffness that is sufficient to support the weight of the earphone 150 yet is formable by the user to freely position the earphone relative to the user's ear. This arrangement eliminates the need for direct contact between the earphone 150 and the user's ear and instead permits the speaker to float proximate to the user's ear by depending downwardly from the support provided by the temple arm of the user's glasses. A stiffening wire can be included within amongst the wires in the cable 160 to impart formability to the cable 160, or a suitable gauge conductive wire can be selected for communication between the earphone 150 and its driving circuitry.

In accordance with a salient aspect of the present invention, the communication headset 110 further includes a grasp 200 which is shaped to secure the housing to the temple arm of a pair of glasses.

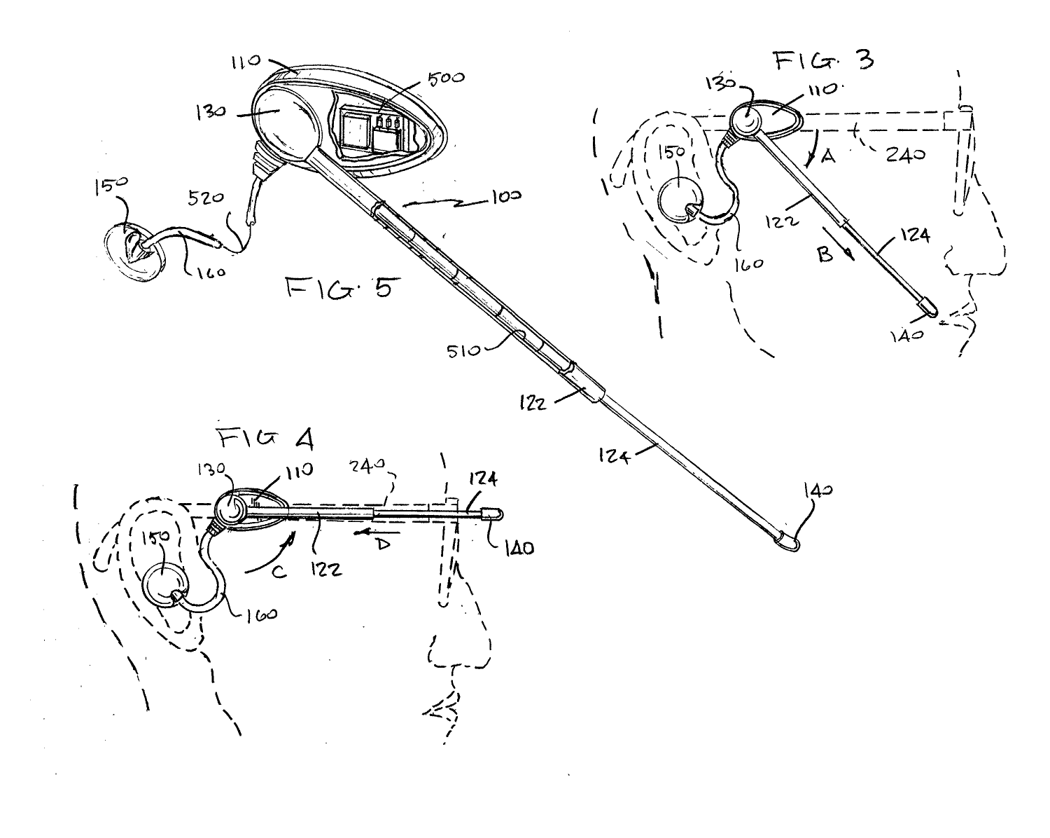

With reference now to FIGS. 2A-2C, three exemplary embodiments of the grasp 200 are illustrated.

In FIG. 2A, the grasp comprises a clip 210 which has opposing contact surfaces which are arranged to grasp and engage securely a temple arm 240 of the glasses. Specifically, the clip includes a contact surface 210B which engages the rear surface 110B of the housing 110. The contact surface 210B rotates about a pivot point adjacent an opposite margin of the rear surface 110B. As illustrated in FIG. 2A, a lever 212 is provided which permits rotation of the clip 210 about a fulcrum 214. A pivot pin 216 and a bias spring 218 complete the clip assembly, in a conventional manner, by normally biasing the contact surface 210B into tight engagement with the rear surface 110B. In this manner, the communication headset 100 can be readily engaged to the temple arm 240 by applying manual pressure to the lever 212 to temporarily separate contact surfaces 110B, 210B and thereby permit the housing 110 to be placed over the temple arm 240. Upon release of the lever 212, the bias 218 (for example, a leaf spring or a coil spring) acts upon the undersurface of the clip 210 to effect rotation about the fulcrum 214 to again place the contact surfaces into tight engagement with one another.

With reference now to FIG. 2B, a second embodiment of the grasp 200′ is described. Like reference numbers are provided on corresponding parts in the drawing figures and following description.

As shown in FIG. 2B, the grasp 200′ includes first and second fingers 220, 230 which are arranged to contact one temple arm 240 of the glasses. More specifically, the first finger 220 includes a ledge 222 which extends from the rear surface 110B of the housing and provides an abutment for a top margin 242 of the temple arm 240. An extension 224 depends downwardly from the free end of the ledge 222 to secure the temple arm 240 between the extension 224 and rear surface 110B of the housing. The second finger 230 is similar to the first finger; however, the ledge 232 is arranged to engage a lower margin 244 of the temple arm, and the extension 234 extends upwardly from the free end of the ledge 232 so as to secure the temple arm 240 between the extension 234 and a rear surface 110B of the housing.

Fig.2C illustrates a further, exemplary embodiment of the grasp 200″ The grasp 200″ includes the first finger 220 and two second fingers 230. The first finger 220 is disposed between the second fingers 230 to provide a three point securement system. Preferably, at least one of the fingers (e.g. fingers 230) is made of a flexible material which permits the temple arm 240 to be pried from the grasp 200″. As in the embodiment of FIG. 2B, the fingers 220 are oriented in the first direction to engage the temple arm along one margin thereof (namely, the top margin 242), whereas the fingers 230 are oriented in a second direction so as to engage the temple arm along an opposing margin (namely, the bottom margin 244).

With reference now to FIG. 3, the communication headset 100 is illustrated in an operative state in which the boom 120 has been rotated in the direction of arrow A and the boom segment 124 has been extended by manual force in the direction of arrow B.

In FIG. 4, the communication headset 100 is shown in a deactuated position in which the boom has been rotated in the direction of arrow C so as to be generally parallel to the temple arm 240, and the segment 124 of the boom 120 has been retracted by manual force in the direction of arrow D.

With reference now to FIG. 5, transceiver circuitry 500 within the housing 110 is illustrated. A transceiver 500 enables bi-direction communication with a communication device associated therewith. It should be understood that the communication headset 100 of the present invention is free of any wires connecting it to a communication device. By way of example only, communications between the communication headset 100 and a cellular telephone or other communication device can use BLUETOOTH® technology, the specifications for which are publically available at the BLUETOOTH® SIG web site, bluetooth.com. Briefly, BLUETOOTH® wireless technology provides a low-power, short-range radio link between two or more of electronic devices to thereby enable reliable transmissions between the devices using frequency hopping, digital packet transfer techniques . Both voice and data can be transmitted using this technology. The frequencies now being used for this technology are in the low gigahertz range, for example, 2.4 gigahertz in the ISM band. BLUETOOTH® is the presently preferred technology because it permits omnidirectional communications and does not require line-of-site visibility. However, wireless communication between the communication headset 100 and a communication device can be by other wireless techniques including, but not limited to, infrared, analog radio waves, etc. The particular manner of communication between the communication headset 100 and the communication device is not material to the present invention.

Preferably, the cable 160 that connects the transceiver circuitry to the earphone 150 serves as an antenna for the transceiver circuitry. FIG. 5 further illustrates a compartment 510 which is sized to receive at least one battery. As illustrated in FIG. 5, a series of batteries can be stacked within the compartment 510 to provide power to the transceiver circuitry 500 and other components included within the communication headset 100.

It should be understood from the foregoing that movement of the boom 120 causes a concomitant movement of the hinge 130 and an actuation of circuitry contained within the housing 110. For example, the hinge 130 can include a contact which either grounds or applies a potential to the gate terminal of a control transistor. The control transistor (not shown) sends, for example, a drain current to further circuitry within the housing to actuate at least the microphone 140 and further circuitry, if such circuitry is not already actuated. Thus, the communication headset 100 can be configured to have substantially all of its circuitry (except for the control circuit that monitors the position of the boom) in a de-actuated state whenever the boom is positioned as shown in FIG. 4, or can be configured to de-actuate less than all the circuitry so that, for example, only the microphone is inactive when the boom is up (as shown in FIG. 4).

The communication headset 100 can implement further features to facilitate a hands-free interaction with a cellular telephone. In particular, the communication headset can be used in combination with voice recognition systems in order to permit the user to dial the cellular telephone simply by pronouncing the digits that are to be dialed, or identifying a pre-programmed party. For example, the spoken word “mom” can be recognized by the voice recognition system and associated with preprogrammed digits to dial the user's mother. When used with such voice recognition systems, a complete user interface is provided by the communication headset, thereby permitting a reduced form factor for the cellular telephone to be used with that headset. In particular, because the microphone and speaker have been relocated to the communication headset 100, the cellular telephone itself can be about the size, for example, of a PCMCIA card and, optionally, can be provided with a flat panel touch screen keypad, superimposed on an active matrix screen, in order to provide keyboard functionality for setting parameters of the cellular telephone, user preferences, and optionally to provide a tablet or keyboard-like input for dialing a telephone.

The communication headset 100 can be used with devices in addition to cellular telephones. The headset can provide MPEG or other encoded music files from a digital recorder or other portable audio player, while still alerting the listener to an incoming cellular call. This functionality exists within the realm of BLUETOOTH® technology. Likewise, the communication headset can provide realtime alerts of pages, messages and incoming e-mail through a link to a suitable switch or router.

Preferably, all the logistics of operating a cellular telephone can be done through a communication headset itself by way of voice recognition circuitry. Voice recognition technology is well known in the patent literature and is does not form a part of the claimed construction. For relevant background reading in this regard, see U.S. Pat. No. 5,717,738, issued Feb. 10, 1998 to Texas Instruments, Inc. of Dallas, Tex., entitled “Method and Device for Generating User Defined Spoken Speed Dial Directories” and U.S. Pat. No. 5,483,579, issued Jan. 9, 1996 to Digital Acoustics, Inc. of Waban, Mass., entitled “Voice Recognition Dialing System.”

From the foregoing, a preferred embodiment of a communication headset 100 has been described which provides a functional interface to cellular telephones and other portable music and alert devices in an arrangement which conveniently and unobtrusively attaches to any pair of conventional glasses.

While the invention has been described in detail with particular reference to certain embodiments thereof, the invention is capable of other and different embodiments, and its details are capable of modifications in various obvious respects. As would be readily apparent to those skilled in the art, variations and modifications can be affected while remaining within the spirit and scope of the invention. Accordingly, the foregoing disclosure, description, and Drawing Figures are for illustrative purposes only, and do not in any way limit the invention, which is defined only by the claims.

I claim:

1. A wireless communication headset for local, bi-directional communication with a communication device, comprising:
a transceiver for bi-directional communication with the communication device;
a housing positioned about the transceiver, the housing having a front surface and a rear surface;
a boom hingedly connected at a first end to the front surface of the housing;
a microphone affixed to the boom at a location remote from the housing;
an earphone connected to the transceiver within the housing; and
a grasp shaped to secure the housing to the temple arm of a pair of glasses.

2. The wireless communication headset as in claim 1, wherein the boom includes at least first and second telescoping segments, wherein one telescoping segment is hingedly connected to the housing and another telescoping segment is affixed to the microphone.

3. The wireless communication headset as in claim 1, further comprising a pair of conductive wires connecting the earphone to the transceiver within the housing.

4. The wireless communication headset as in claim 1, wherein the grasp comprises a clip.

5. The wireless communication headset as in claim 4, wherein the clip has opposing contact surfaces and a bias such that the opposing contact surfaces normally engage one another.

6. The wireless communication headset as in claim 1, wherein the grasp comprises at least first and second fingers arranged to contact the temple arm of the glasses.

7. The wireless communication headset as in claim 6, wherein there are first, second and third fingers, two of the fingers oriented in a first direction to engage the temple arm along one margin thereof and the third finger oriented in a second direction to engage the temple arm from an opposing margin thereof.

8. The wireless communication headset as in claim 1, further comprising at least two conductive wires connecting the earphone to the transceiver within the housing.

9. The wireless communication headset as in claim 8, wherein at least one of the conductive wires is connected to an antenna port of the transceiver.

10. The wireless communication headset as in claim 1, further comprising a compartment contained within the boom sized to receive at least one battery.

11. The wireless communication headset as in claim 1, wherein the boom has a first position and a second position, the transceiver being operative to actuate at least the microphone when the boom is in the first position and to de-actuate at least the microphone when the boom is in the second position.

12. A wireless communication headset for local, bi-directional communication with a communication device, comprising:
a transceiver for bi-directional communication with the communication device;
a housing positioned about the transceiver, the housing having a front surface and a rear surface;
a boom hingedly connected at a first end to the front surface of the housing, the boom including at least first and second telescoping segments, the first telescoping segment being hingedly connected to the housing;
a microphone affixed to the second telescoping segment of the boom so as to be positioned at a location remote from the housing;
an earphone connected to the transceiver within the housing; and
a grasp shaped to secure the housing to the temple arm of a pair of glasses,
wherein the boom has a first position and a second position, the transceiver being operative to actuate at least the microphone when the boom is in the first position and to de-actuate at least the microphone when the boom is in the second position.
